(19) United States
(12) Patent Application Publication
(10) Pub. No.: US 2023/0126716 A1
(43) Pub. Date: Apr. 27, 2023

(54) NETWORK MONITORING

(71) Applicant: Elisa Oyj, Helsinki (FI)

(72) Inventor: Henri KARIKALLIO, Helsinki (FI)

(73) Assignee: Elisa Oyj, Helsinki (FI)

(21) Appl. No.: 17/915,692

(22) PCT Filed: Apr. 7, 2021
(86) PCT No.: PCT/FI2021/050252

§ 371 Date: Sep. 29, 2022

(30) Foreign Application Priority Data
Apr. 14, 2020 (FI) 20205385

(51) Int. Cl. H04L 41/0604

(52) U.S. Cl. CPC H04L 41/0613; H04L 41/0627

(57) ABSTRACT

A computer implemented method of monitoring operation of a communication network for the purpose of controlling the communication network. The method includes monitoring data relating to failures in the communication network; identifying a first set of failures comprising a statistically significant number of substantially similar failures; detecting that statistically significant number of failures of said first set of failures is associated with at least one common component, and responsively, outputting an alert related to the common component.

### TECHNICAL FIELD

The present application generally relates to automated communication network monitoring.

### BACKGROUND

This section illustrates useful background information without admission of any technique described herein representative of the state of the art.

Cellular communication networks comprise a plurality of cells serving users of the network. When users of the communication network move in the area of the network, connections of the users are seamlessly handed over between cells of the network.

In order to provide good quality of service for users of the network, different parts of the network need to operate as intended. Network operators constantly monitor operation of the network to be able to identify and fix any problems without delay. There are various automatic monitoring methods for this purpose.

Now a new automatic monitoring method is provided.

### SUMMARY

Various aspects of examples of the invention are set out in the claims. Any devices and/or methods in the description and/or drawings which are not covered by the claims are examples useful for understanding the invention.

According to a first example aspect of the present invention, there is provided a computer implemented method of monitoring operation of a communication network for the purpose of controlling the communication network. The method comprises
monitoring data relating to failures in the communication network;
identifying a first set of failures comprising a statistically significant number of substantially similar failures;
detecting that statistically significant number of failures of said first set of failures is associated with at least one common component, and responsively, outputting an alert related to the common component.

In an example embodiment, the data related to failures comprises at least one or more of the following: failure alarms, customer complaints, automatically generated maintenance tickets, information about automatically performed failure corrections, explanatory notes related to maintenance tickets, increased energy consumption, and performance indicator data.

In an example embodiment, identifying the first set of failures is based on comparing failure frequency during a monitored time period to a failure frequency during a reference time period.

In an example embodiment, identifying the first set of failures is based on comparing failure frequency in certain geographical area to a failure frequency in a reference area.

In an example embodiment, detecting that statistically significant number of failures of said first set of failures is associated with at least one common component is based on comparing failure frequency in a first component setup comprising the common component and failure frequency in a reference setup.

In an example embodiment, the common component is a component of a first type.

In an example embodiment, the common component is a jumper.

In an example embodiment, the common component is a component with a first software version.

In an example embodiment, the common component is a component with a first combination of software, firmware and/or hardware.

According to a second example aspect of the present invention, there is provided an apparatus comprising a processor and a memory including computer program code; the memory and the computer program code configured to, with the processor, cause the apparatus to perform the method of the first aspect or any related embodiment.

According to a third example aspect of the present invention, there is provided a computer program comprising computer executable program code which when executed by a processor causes an apparatus to perform the method of the first aspect or any related embodiment.

The computer program of the third aspect may be a computer program product stored on a non-transitory memory medium.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows an example scenario according to an embodiment;

FIG. 2 shows an apparatus according to an embodiment;

FIGS. 3-4 show flow diagrams illustrating example methods according to certain embodiments; and

FIG. 5 shows some examples of component setups.

### DETAILED DESCRIPTION OF THE DRAWINGS

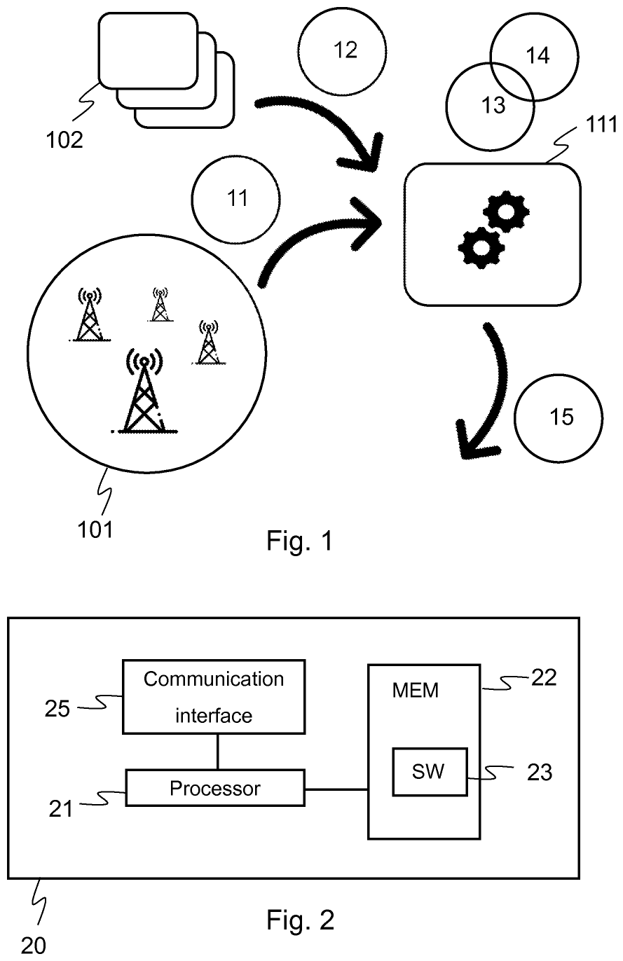

Example embodiments of the present invention and its potential advantages are understood by referring to FIGS. 1 through 5 of the drawings. In this document, like reference signs denote like parts or steps.

Example embodiments of the invention provide new mechanisms to monitor and analyze operation of communication networks. Certain example embodiments are based on analyzing failures detected in operation of the network with the aim to identify situations where certain equipment or equipment setup may be the root cause of the failures.

It has been noted that automatic network monitoring may repeatedly detect failures in certain cell or base station. Likewise, plurality of similar failures may repeatedly occur in customer complaints or other sources of data relating to failures. In some cases, the repeated failures may lead to repeated replacement of physical equipment or at least repeated visits to base station site by maintenance personnel. The root cause for such repeated failures may be certain component or component setup that does not operate as intended and if the component is changed to another one, the repeated failures may disappear. Simply replacing the component with a new component of exactly same type may appear to be the solution if there is a failure associated with the component, but this does not always solve the problem permanently. Instead, the same problem may reoccur within a short period of time. In such cases, repairing the root cause (i.e. changing the component to another one) is clearly beneficial and likely to provide cost savings and improved user experience. Various embodiments of the invention provide alerts that flag out such potential root cause of problems and based on which the potential root cause may be repaired.

FIG. 1 shows an example scenario according to an embodiment. The scenario shows a communication network 101 comprising a plurality of cells and base stations and other network devices, and an automation system 111 configured to implement (automatic) network monitoring according to example embodiments. Additionally, FIG. 1 shows data sources 102 relating to failures in the communication network 101. The data sources 102 may comprise for example one or more of the following: customer complaints, automatically generated maintenance tickets, information about automatically performed failure corrections, explanatory notes related to maintenance tickets, information about energy consumption.

In an embodiment of the invention the scenario of FIG. 1 operates as follows: In phases 11 and 12, the automation system 111 obtains data relating to failures in the communication network. The data may be obtained from various sources such as from the cells of the network 101 and/or the data sources 102.

In phase 13, the automation system 111 analyses the failures and identifies a first set of failures comprising a statistically significant number of substantially similar failures.

In phase 14, it is detected that statistically significant number of failures in the first set of failures is associated with at least one common component. It is to be noted that if statistically significant number of similar failures or a common component are not detected, the process may stop or continue monitoring and analyzing further data relating to failures.

In phase 15, the automation system 111 outputs an alert when at least one common component is detected in the analysis of phase 14. Based on the alert, network operator may make an educated decision about changing one or more components in the network. For example, software or firmware version may be changed, component type may be changed, component vendor may be changed etc.

The analysis of phases 13 and 14 may be repeated for example once a day, every other day, every three days, once a week, every two weeks, once a month, or every two months or after some other period of time. By periodically repeating the analysis, changes performed in the network on the basis of the alerts may result in efficient improvements in the network and help avoiding repeated degradation of quality of service.

FIG. 2 shows an apparatus 20 according to an embodiment. The apparatus 20 is for example a general-purpose computer or server or some other electronic data processing apparatus. The apparatus 20 can be used for implementing embodiments of the invention. That is, with suitable configuration the apparatus 20 is suited for operating for example as the automation system 111 of foregoing disclosure.

The general structure of the apparatus 20 comprises a processor 21, and a memory 22 coupled to the processor 21. The apparatus 20 further comprises software 23 stored in the memory 22 and operable to be loaded into and executed in the processor 21. The software 23 may comprise one or more software modules and can be in the form of a computer program product. Further, the apparatus 20 comprises a communication interface 25 coupled to the processor 21.

The processor 21 may comprise, e.g., a central processing unit (CPU), a microprocessor, a digital signal processor (DSP), a graphics processing unit, or the like. FIG. 2 shows one processor 21, but the apparatus 20 may comprise a plurality of processors.

The memory 22 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories.

The communication interface 25 may comprise communication modules that implement data transmission to and from the apparatus 20. The communication modules may comprise, e.g., a wireless or a wired interface module. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. Further the apparatus 20 may comprise a user interface (not shown) for providing interaction with a user of the apparatus. The user interface may comprise a display and a keyboard, for example. The user interaction may be implemented through the communication interface 25, too.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like. Further, it is noted that only one apparatus is shown in FIG. 2, but the embodiments of the invention may equally be implemented in a cluster of shown apparatuses.

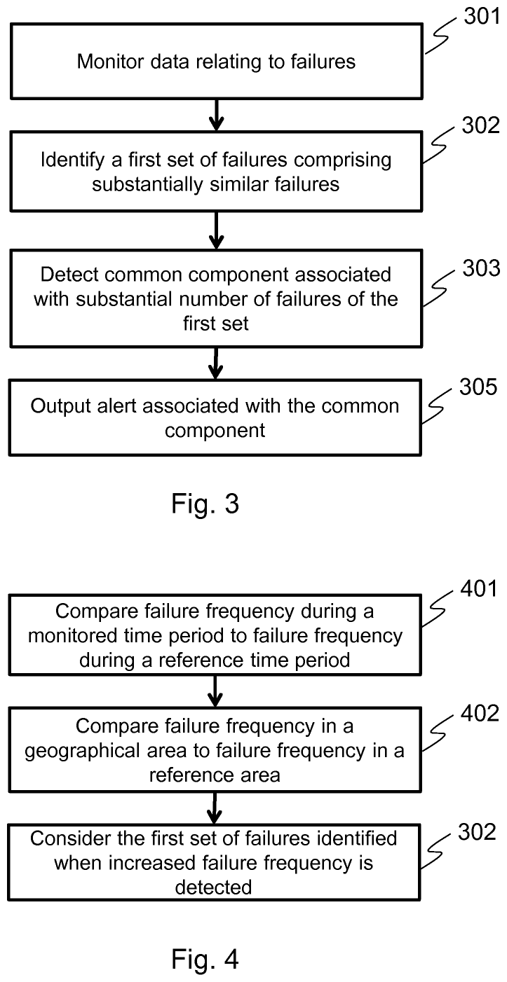

FIGS. 3 and 4 show flow diagrams illustrating example methods according to certain embodiments. The methods may be implemented in the automation system 111 of FIG. 1 and/or in the apparatus 20 of FIG. 2. The methods are implemented in a computer and do not require human interaction unless otherwise expressly stated. It is to be noted that the methods may however provide output that may be further processed by humans and/or the methods may require user input to start. Different phases shown in FIGS. 3 and 4 may be combined with each other and the order of phases may be changed except where otherwise explicitly defined. Furthermore, it is to be noted that performing all phases of the flow charts is not mandatory.

The method of FIG. 3 provides monitoring operation of a communication network (101) for the purpose of controlling the communication network, and comprises following phases:

Phase 301: Data relating to failures in a communication network is being monitored. The data may be obtained from a plurality of different sources and may comprise at least one or more of the following: failure alarms, customer complaints, automatically generated maintenance tickets, information about automatically performed failure corrections, explanatory notes related to maintenance tickets, increased energy consumption, performance indicator data.

Phase 302: A first set of failures is identified. The first set of failures comprises a statistically significant number of substantially similar failures. For example: failure alarms may repeatedly indicate certain type of failure in certain base stations; customer complaints may indicate repeated problems in certain cells; automatically generated maintenance tickets may be repeatedly generated for certain base stations; automatically performed failure corrections may comprise continuous resets in certain cells during certain time period; explanatory notes related to maintenance tickets may show significant number of component changes; energy consumption in certain base stations may have increased during certain time period, while energy consumption in other base stations remains substantially the same as before; performance indicator data may exceed predefined threshold in plurality of cells. It is to be noted that this is non-exhaustive list and also other data sources and other types of failures may be monitored.

Statistically significant number of failures may be very different in different cases. In some cases, even a small number of failures may be statistically significant and in other cases larger amount of failures is required.

The flow diagram of FIG. 4 illustrates some examples of implementing the phase 302. In phase 401, failure frequency (or number of failures) during a monitored time period is compared to a failure frequency (or number of failures) during a reference time period (e.g. earlier time period). In phase 402, failure frequency (or number of failures) in certain geographical area is compared to a failure frequency (or number of failures) in a reference area (e.g. larger area or other similar area). Then it may be analysed whether there is significant difference in failure frequencies. When increased failure frequency is detected, it is considered that the first set of failures has been identified in phase 302.

In an example embodiment, the substantially similar failures may refer to exactly the same failure occurring multiple times and/or the exactly same failure occurring in multiple places. Alternatively, multiple occurrences of similar failures suffice. For example, customer complaints in certain geographical area may be considered substantially similar even though the content of the complaint may be different. In another example, automatically performed failure corrections occurring the same time of the day may be considered substantially similar even though the failure correction may be different. In yet another example, explanatory notes related to maintenance tickets including certain key work such as “jumper” may be considered substantially similar even though the explanatory notes may be otherwise very different from each other.

The analysis of phase 302 may be performed for data obtained over a period certain of time. The period of time may be for example a week, two weeks, a month, two months or six months or some other period of time. In an example embodiment, there may be short-term evaluation and long-term evaluation that are performed simultaneously or only short-term or long-term evaluation may be chosen to be performed. For example, there may be evaluation over one-week period and evaluation over three-month period. A benefit of long-term evaluation is that sudden disruptions in network operation are ignored do not cause extensive action. Whereas a short-term evaluation provides the benefit of enabling quick reactions to problems in the network.

In an example case where energy consumption is monitored, there may be a short-term evaluation and a long-term evaluation. For example, at least 15% increase on weekly energy consumption or at least 10% increase over a 3-month period may be required for detection of increased energy consumption and identification of a first set of failures. The component setups exhibiting increased energy consumption may be then analysed for finding out whether they (or significant number of them) are associated with a common component that may be the root cause for the increased energy consumption. Substantial increase in energy consumption may be an indication of a malfunctioning component, but normal failure monitoring does not necessarily detect any problem. The embodiment where energy consumption is monitored provides the effect of being able to detect and repair such cases.

Phase 303: Common component associated with statistically significant number of failures in the first set of failures is detected. For example, if at least certain percentage of failures of the identified first set are associated with a component setup that comprises certain component type, then that certain component type may be considered to be the common component in the sense of present disclosure. The common component may be component of a certain type, component of a certain vendor, a combination of a certain component and certain software versions, a combination of a certain component with certain hardware, firmware and/or software. The percentage may be for example 30-70%. As a clarification, it is to be noted that statistically significant number is required twice: first it is required that the first set of statistically significant number of similar failures are identified in phase 302. Then, after identifying the first set of failures, it is required that within the first set of failures, there is a statistically significant number of failures associated with a common component. All failures of the first set need not relate to the common component, though.

It is to be noted that if statistically significant number of similar failures or a common component are not detected, the process may stop or continue monitoring and analyzing further data relating to failures.

Phase 305: An alert associated with the common component is output, when at least one common component is detected in phase 303. Based on the alert, network operator may make an educated decision about changing one or more components in the network. For example, software or firmware version may be changed, component type may be changed, component vendor may be changed etc.

In an example case, there are 100 maintenance visits to a base station site and 30 of these are associated with an explanatory note including the term “jumper”. Now if the 30 cases (or almost all of them) relate to a setup having the same jumper type, the method according to various embodiments results in an alert associated with the identified jumper type.

In another example case, there are 100 automatically performed failure corrections and 75 of these are associated with a setup comprising certain network equipment with certain software version. In such case the method according to various embodiments results in an alert associated with the software version (or combination of the network equipment type and software version).

In an embodiment, detecting e.g. in phase 303 of FIG. 3 that statistically significant number of failures of said first set of failures is associated with at least one common component is based on comparing failure frequency (or number of failures) in a first component setup comprising the common component and failure frequency (or number of failures) in a reference setup. The information relating to the reference setup may be obtained from historical data, i.e. data earlier collected from the network and other sources.

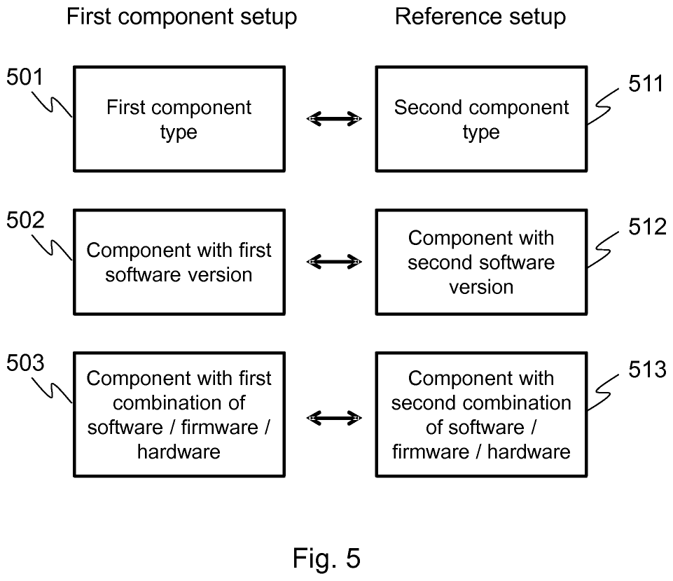

FIG. 5 shows some examples of component setups. FIG. 5 shows a plurality of pairs of a first component setup and a reference setup. In general, the reference setup, that is used in some embodiments, is a component setup that is comparable with the first component setup.

In a first example case of FIG. 5, a first component setup 501 comprises a first component type and a reference setup 511 comprises second type of a respective component. The first and second types may be different versions of the same component or components manufactured by different vendors, for example.

In a second example case of FIG. 5, a first component setup 502 comprises a component with a first software version and a reference setup 512 comprises the same component with a second software version.

In a third example case of FIG. 5, a first component setup 503 comprises a component with a first combination of software, firmware and/or hardware and a reference setup 513 comprises a second combination of software, firmware and/or hardware.

Without in any way limiting the scope, interpretation, or application of the claims appearing below, a technical effect of one or more of the example embodiments disclosed herein is ability to detect possible root cause for failures in network. In this way it is possible to improve operation of the network and to provide cost savings in network maintenance actions.

Another technical effect of one or more of the example embodiments disclosed herein is ability improve user experience by reducing failures in the network.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications, which may be made without departing from the scope of the present invention as defined in the appended claims.

1-11. (canceled)

12. A computer implemented method of monitoring operation of a communication network for the purpose of controlling the communication network, the method comprising
monitoring data relating to failures in the communication network, wherein the data related to failures consists at least one of: automatically generated maintenance tickets, information about automatically performed failure corrections, explanatory notes related to maintenance tickets, and increased energy consumption;
identifying a first set of failures comprising a statistically significant number of substantially similar failures;
detecting, after identifying the first set of failures, that statistically significant number of failures of said first set of failures is associated with at least one common component, and responsively, outputting an alert related to the common component.

13. The method of claim 1, wherein the data related to failures consists at least one or more of the following: automatically generated maintenance tickets, information about automatically performed failure corrections, and explanatory notes related to maintenance tickets.

14. The method of claim 1, wherein the alert that is output is to change software or firmware version of the component, to change type of the component, or to change vendor of the component.

15. The method of claim 1, wherein identifying the first set of failures is based on comparing failure frequency during a monitored time period to a failure frequency during a reference time period.

16. The method of claim 1, wherein identifying the first set of failures is based on comparing failure frequency in certain geographical area to a failure frequency in a reference area.

17. The method of claim 1, wherein detecting that statistically significant number of failures of said first set of failures is associated with at least one common component is based on comparing failure frequency in a first component setup comprising the common component and failure frequency in a reference setup.

18. The method of claim 1, wherein the common component is a component of a first type.

19. The method of claim 1, wherein the common component is a jumper.

20. The method of claim 1, wherein the common component is a component with a first software version.

21. The method claim 1, wherein the common component is a component with a first combination of software, firmware and/or hardware.

22. An apparatus comprising:
a processor, and
a memory including computer program code; the memory and the computer program code configured to, with the processor, cause the apparatus to perform monitoring operation of a communication network for the purpose of controlling the communication network by:
monitoring data relating to failures in the communication network, wherein the data related to failures consists at least one of: automatically generated maintenance tickets, information about automatically performed failure corrections, explanatory notes related to maintenance tickets, and increased energy consumption;
identifying a first set of failures comprising a statistically significant number of substantially similar failures;
detecting, after identifying the first set of features, that statistically significant number of failures of said first set of failures is associated with at least one common component, and responsively, outputting an alert related to the common component.

23. A non-transitory memory medium comprising computer executable program code which when executed by a processor causes an apparatus to perform monitoring operation of a communication network for the purpose of controlling the communication network by:
monitoring data relating to failures in the communication network, wherein the data related to failures consists at least one of: automatically generated maintenance tickets, information about automatically performed failure corrections, explanatory notes related to maintenance tickets, and increased energy consumption;
identifying a first set of failures comprising a statistically significant number of substantially similar failures;
detecting, after identifying the first set of features, that statistically significant number of failures of said first set of failures is associated with at least one common component, and responsively, outputting an alert related to the common component.
